(19) United States
(12) Patent Application Publication
(10) Pub. No.: US 2017/0153738 A1
(43) Pub. Date: Jun. 1, 2017

(54) DUAL LAYER FORCE SENSITIVE RESISTOR SENSOR

(71) Applicant: Flex Ltd., Singapore (SG)

(72) Inventors: Jiayin Ma, Palo Alto, CA (US); Shaily Deva, Saratoga, CA (US)

(21) Appl. No.: 15/365,203

(22) Filed: Nov. 30, 2016

Related U.S. Application Data
(60) Provisional application No. 62/261,124, filed on Nov. 30, 2015.

(51) Int. Cl. G06F 3/041; G01L 1/14; G01L 1/20; G06F 3/044; G06F 3/045

(52) U.S. Cl. CPC G06F 3/0414; G06F 3/044; G06F 3/045; G01L 1/205; G01L 1/146

(57) ABSTRACT

According to one embodiment, a multi-layer force sensor can comprise two or more Force Sensitive Resistors (FSRs), Force Sensitive Capacitors (FSCs), or other force sensitive devices. Each of these force sensitive devices can comprise a different layer of the multi-layer force sensor. Additionally, each of these different layers can be constructed of a different material providing different responses, i.e., different resistance, conductance, etc., over the same range of pressure or force. As a force is applied to the multi-layer sensor, this difference in response to the force between the layers can be used to determine a value for the force. The multi-layer force sensor can be implemented in a bridge circuit. The bridge circuit can be used to measure the differences in resistance, conductance, etc. between the different layers of the multi-layer sensor.

### CROSS REFERENCE TO RELATED APPLICATION

The present application claims the benefits of and priority, under 35 U.S.C. §119(e), to U.S. Provisional Application No. 62/261,124 filed Nov. 30, 2015 by Ma and entitled “Dual Layer Force Sensitive Resistor Sensor” of which the entire disclosure is incorporated herein by reference for all purposes.

### FIELD OF THE DISCLOSURE

Embodiments of the present disclosure relate generally to methods and systems for force sensitive resistance sensors and more particularly to a dual layer force sensitive resistance sensor.

### BACKGROUND

Existing Force Sensitive Resistor (FSR) sensors measure the resistance/conductivity of FSR materials (e.g. elastomer, foam or conductive ink) between two points when pressure is applied. Traditionally, FSR sensors provide very wide measurement range with very fast sampling rate. However, the relatively low sensitivity and thermally unstable nature of traditional FSR sensors may be unfavorable in many applications. Hence, there is a need for improved methods and systems for improved force sensors.

### BRIEF SUMMARY

Embodiments of the disclosure provide systems and methods for a dual or multi-layer force sensor. The multi-layer force sensor can comprise two or more Force Sensitive Resistors (FSRs), Force Sensitive Capacitors (FSCs), or other force sensitive devices. Each of these force sensitive devices can comprise a different layer of the multi-layer force sensor. Additionally, each of these different layers can be constructed of a different material providing different responses, i.e., different resistance, conductance, etc., over the same range of pressure or force. As a force is applied to the multi-layer sensor, this difference in response to the force between the layers can be used to determine a value for the force. That is, rather than using the changing resistance, capacitance, or other characteristic of a single force sensitive device to determine the amount of force applied, embodiments of the present invention use the difference in the response between two or more such devices to determine the amount of force applied. This can improve the sensor's performance in terms of sensitivity, accuracy, and thermal stability.

A multi-layer force sensor can be implemented in a bridge circuit. A bridge circuit is a type of electrical circuit in which two circuit branches (usually in parallel with each other) are “bridged” by a third branch connected between the first two branches at some intermediate point along them. The bridge was originally developed for laboratory measurement purposes. In this implementation, the bridge circuit can be used to measure the differences in resistance, conductance, etc. between the different layers of the multi-layer sensor. The measurement of these differences can be more sensitive to the applied force/pressure than direct measurement, especially at high pressure/force range. Because the thermal conditions at the different layers of the multi-layer sensor are the same, the measurement of difference in resistance or conductance between the layers is much less sensitive to thermal condition and variation than direct measurement of resistance and conductance.

According to one embodiment, a multi-layer force sensor can comprise a first force sensitive layer of a first force sensitive material and a second force sensitive layer of a second force sensitive material. A response of a characteristic of the first force sensitive material for a range of force applied to the multi-layer force sensor can be different from a response of the same characteristic of the second force sensitive material for the same range of force applied to the multi-layer force sensor. A difference between the response of the first force sensitive material and the response of the second force sensitive material can indicate an amount of force applied to the multi-layer force sensor.

In some cases, an intermediate layer may be disposed between the first force sensitive layer and the second force sensitive layer. One or more conductive leads may be electrically connected with each or the first force sensitive layer and the second force sensitive layer. The first force sensitive layer can comprise, for example, a first Force Sensitive Resistor (FSR) and the second force sensitive layer can comprise a second FSR. The first force sensitive material and the second force sensitive material comprise a conductive elastomer, a conductive foam, or a conductive ink. In such cases, the characteristic can comprise resistance of the first force sensitive material and the second force sensitive material. In another implementation, the first force sensitive layer can comprise a first Force Sensitive Capacitor (FSC) and the second force sensitive layer can comprise a second FSC. In such a case, the characteristic can comprise capacitance of the first force sensitive material and the second force sensitive material.

According to another embodiment, a bridge circuit can comprise a first force sensitive layer of a multi-layer force sensor and comprising a first force sensitive material and a second force sensitive layer of the multi-layer force sensor electrically connected with the first force sensitive layer at a first intermediate point of the bridge circuit and comprising a second force sensitive material. A response of a characteristic of the first force sensitive material for a range of force applied to the multi-layer force sensor can be different from a response of the same characteristic of the second force sensitive material for the same range of force applied to the multi-layer force sensor. A first bridge resistor can be electrically connected with the first force sensitive layer of the multi-layer sensor at a second intermediate point of the bridge circuit and a second bridge resistor can be electrically connected with the first bridge resistor at a third intermediate point of the bridge circuit and the second force sensitive layer of the multi-layer force sensor at a fourth intermediate point of the bridge circuit. A difference between the response of the first force sensitive material and the response of the second force sensitive material can be measured between the second intermediate point of the bridge circuit and fourth intermediate point of the bridge circuit. The measured difference can indicate an amount of force applied to the multi-layer force sensor.

According to yet another embodiment, a method for measuring force using a multi-layer force sensor can comprise receiving a force applied to the multi-layer force sensor. The multi-layer force sensor can comprise a first force sensitive layer of a first force sensitive material and a second force sensitive layer of a second force sensitive material. A response of a characteristic of the first force sensitive material for a range of force applied to the multi-layer force sensor is different from a response of the same characteristic of the second force sensitive material for the same range of force applied to the multi-layer force sensor. A difference between the response of the first force sensitive material and the response of the second force sensitive material can be detected and a value for a amount of force applied to the multi-layer force sensor can be determined based on the detected difference between the response of the first force sensitive material and the response of the second force sensitive material.

For example, the multi-layer force sensor can comprise a bridge circuit, wherein the second force sensitive layer is electrically connected with the first force sensitive layer at a first intermediate point of the bridge circuit, wherein a first bridge resistor is electrically connected with the first force sensitive layer of the multi-layer sensor at a second intermediate point of the bridge circuit, wherein a second bridge resistor electrically connected with the first bridge resistor at a third intermediate point of the bridge circuit and the second force sensitive layer of the multi-layer force sensor at a fourth intermediate point of the bridge circuit. In such cases, the difference in response of the first and second force sensitive materials can be detected between the second intermediate point of the bridge circuit and fourth intermediate point of the bridge circuit. The first force sensitive layer can comprise, for example, a first Force Sensitive Resistor (FSR) and the second force sensitive layer can comprise a second FSR. In such cases, the characteristic can comprise resistance of the first force sensitive material and the second force sensitive material. The first force sensitive material and the second force sensitive material can comprise a conductive elastomer, a conductive foam, or a conductive ink. In another implementation, the first force sensitive layer can comprise a first Force Sensitive Capacitor (FSC) and the second force sensitive layer can comprise a second FSC. In such cases, the characteristic can comprise capacitance of the first force sensitive material and the second force sensitive material.

### BRIEF DESCRIPTION OF THE DRAWINGS

FIG. 1A is a diagram illustrating a cross-sectional view of a multi-layer force sensor according to one embodiment.

FIG. 1B is a diagram illustrating a cross-sectional exploded view of a multi-layer force sensor according to one embodiment.

FIG. 2 is a schematic diagram of a bridge circuit including a plurality of layers of a multi-layer sensor according to one embodiment.

FIG. 3 is a graph illustrating a difference between response characteristics of layers of a multi-layer force sensor according to one embodiment.

FIG. 4 is a flowchart illustrating a method for measuring force using a multi-layer force sensor according to one embodiment.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosured herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Embodiments of the disclosure provide systems and methods for a dual or multi-layer force sensor. The multi-layer force sensor can comprise two or more Force Sensitive Resistors (FSRs), Force Sensitive Capacitors (FSCs), or other force sensitive devices. Each of these force sensitive devices can comprise a different layer of the multi-layer force sensor. Additionally, each of these different layers can be constructed of a different material providing different responses, i.e., different resistance, conductance, etc., over the same range of pressure or force. As a force is applied to the multi-layer sensor, this difference in response to the force between the layers can be used to determine a value for the force. That is, rather than using the changing resistance, capacitance, or other characteristic of a single force sensitive device to determine the amount of force applied, embodiments of the present invention use the difference in the response between two or more such devices to determine the amount of force applied. This can improve the sensor's performance in terms of sensitivity, accuracy, and thermal stability.

A multi-layer force sensor can be implemented in a bridge circuit. A bridge circuit is a type of electrical circuit in which two circuit branches (usually in parallel with each other) are “bridged” by a third branch connected between the first two branches at some intermediate point along them. The bridge was originally developed for laboratory measurement purposes. In this implementation, the bridge circuit can be used to measure the differences in resistance, conductance, etc. between the different layers of the multi-layer sensor. The measurement of these differences can be more sensitive to the applied force/pressure than direct measurement, especially at high pressure/force range. Because the thermal conditions at the different layers of the multi-layer sensor are the same, the measurement of difference in resistance or conductance between the layers is much less sensitive to thermal condition and variation than direct measurement of resistance and conductance.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

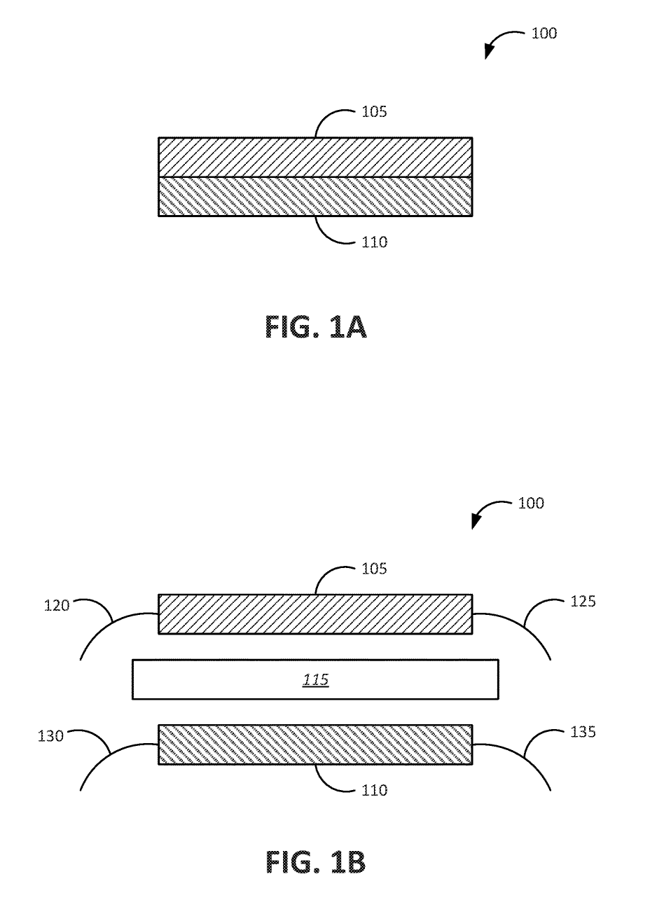

FIG. 1A is a diagram illustrating a cross-sectional view of a multi-layer force sensor according to one embodiment. As illustrated in this example, a multi-layer force sensor 100 can comprise a first force sensitive layer 105 of a first force sensitive material and a second force sensitive layer 110 of a second force sensitive material. As illustrated here, the first force sensitive layer 105 and second force sensitive layer 110 can be disposed adjacent to one another or similarly situated so that a force applied to the multi-layer force sensor 100 will be equally applied to both the first force sensitive layer 105 and the second force sensitive layer 110. A response of a characteristic, i.e., a response characteristic of characteristic of the material that changes in response to an applied force, of the first force sensitive material for a range of force applied to the multi-layer force sensor can be different from a response of the same characteristic of the second force sensitive material for the same range of force applied to the multi-layer force sensor. A difference between the response of the first force sensitive material and the response of the second force sensitive material can indicate an amount of force applied to the multi-layer force sensor 100.

FIG. 1B is a diagram illustrating a cross-sectional exploded view of a multi-layer force sensor according to one embodiment. More specifically, this example illustrates the multi-layer force sensor 100 of FIG. 1A including the first force sensitive layer 105 and second force sensitive layer 110. In some cases, an intermediate layer 115 may be disposed between the first force sensitive layer 105 and the second force sensitive layer 110. The intermediate layer 115, if any, may be a variety of different materials including but not limited to a flexible, rigid, or semi-rigid polymer, elastomer, adhesive, etc. or a combination of these and/or other materials. One or more conductive leads may be electrically connected with each or the first force sensitive layer 105 and the second force sensitive layer 110.

The first force sensitive layer 105 can comprise, for example, a first Force Sensitive Resistor (FSR) and the second force sensitive layer 110 can comprise a second FSR. The first force sensitive material and the second force sensitive material comprise a conductive elastomer, a conductive foam, or a conductive ink. In such cases, the response characteristic can comprise resistance of the first force sensitive material and the second force sensitive material. In another implementation, the first force sensitive layer 105 can comprise a first Force Sensitive Capacitor (FSC) and the second force sensitive layer 110 can comprise a second FSC. In such a case, the response characteristic can comprise capacitance of the first force sensitive material and the second force sensitive material.

Each of these different layers can be constructed of a different material providing different responses, i.e., different resistance, conductance, etc., over the same range of pressure or force. As a force is applied to the multi-layer sensor, this difference in response to the force between the layers can be used to determine a value for the force. That is, rather than using the changing resistance, capacitance, or other characteristic of a single force sensitive device to determine the amount of force applied, embodiments of the present invention use the difference in the response between two or more such devices to determine the amount of force applied. The measurement of these differences can be more sensitive to the applied force/pressure than direct measurement, especially at high pressure/force range. Because the thermal conditions at the different layers of the multi-layer sensor are the same, the measurement of difference in resistance or conductance between the layers is much less sensitive to thermal condition and variation than direct measurement of resistance and conductance.

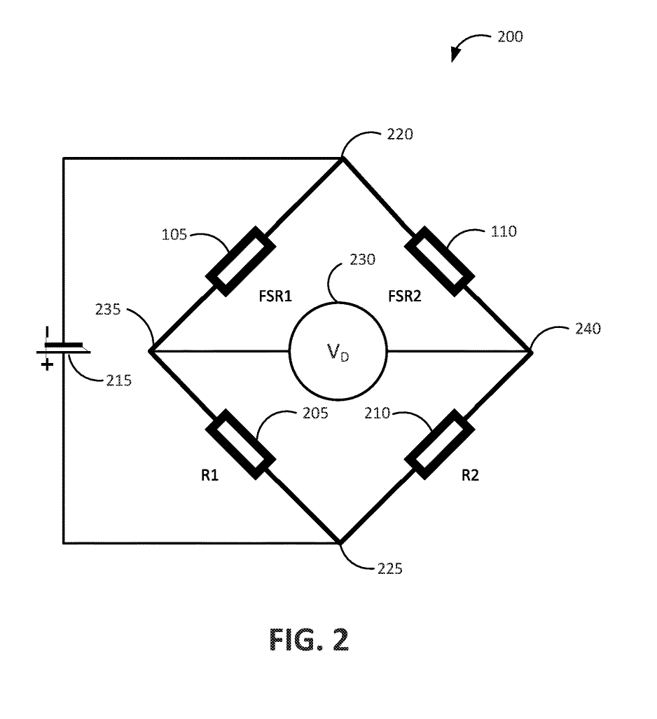

FIG. 2 is a schematic diagram of a bridge circuit including a plurality of layers of a multi-layer sensor according to one embodiment. As introduced above, a multi-layer force sensor 100 can be implemented in a bridge circuit 200. In this implementation, the bridge circuit 200 can be used to measure the differences in resistance, conductance, etc. between the different layers 105 and 110 of the multi-layer sensor 100 as described above.

More specifically, and according to one embodiment, a bridge circuit 200 can comprise a first force sensitive layer (FSR1, in this example) 105 of a multi-layer force sensor 100 and comprising a first force sensitive material. A second force sensitive layer (FSR2, in this example) 110 of the multi-layer force sensor 100 comprising a second force sensitive material can be electrically connected with the first force sensitive layer 105 at a first intermediate point 220 of the bridge circuit 200 and. As described above, a response characteristic of the first force sensitive material for a range of force applied to the multi-layer force sensor 100 can be different from the same response characteristic of the second force sensitive material for the same range of force applied to the multi-layer force sensor 100.

A first bridge resistor (R1, in this example) 205 can be electrically connected with the first force sensitive layer 105 of the multi-layer sensor 100 at a second intermediate point 235 of the bridge circuit 200. A second bridge resistor (R2, in this example) 210 can be electrically connected with the first bridge resistor 205 at a third intermediate point 225 of the bridge circuit 200. The second bridge resistor 210 can also be electrically connected with the second force sensitive layer 110 of the multi-layer force sensor 100 at a fourth intermediate point 240 of the bridge circuit 200. In this arrangement, the first force sensitive layer 105 is connected in series with the first bridge resistor 205 between the first intermediate point 220 and third intermediate point 225. Similarly, the second force sensitive layer 110 is connected in series with the second bridge resistor 210 between the first intermediate point 220 and third intermediate point 225. The branch including the first force sensitive layer 105 and first bridge resistor 205 is therefore connected in parallel with the branch including the second force sensitive layer 110 and second bridge resistor 210.

In use, a power source 215 can be applied to the first intermediate point 220 and third intermediate point 225 of the bridge circuit. When a force is then applied to the multi-layer force sensor 100, a change in the response characteristics, e.g., resistance, of the first force sensitive layer 105 and second force sensitive layer 110 can be detected and measured. As illustrated here, the difference between the response of the first force sensitive layer 105 and the response of the second force sensitive layer 110 can be measured between the second intermediate point 235 and fourth intermediate point 240 of the bridge circuit 200 as indicated in this example by the detected voltage V_{D} 230. The measured difference can indicate an amount of force applied to the multi-layer force sensor 100.

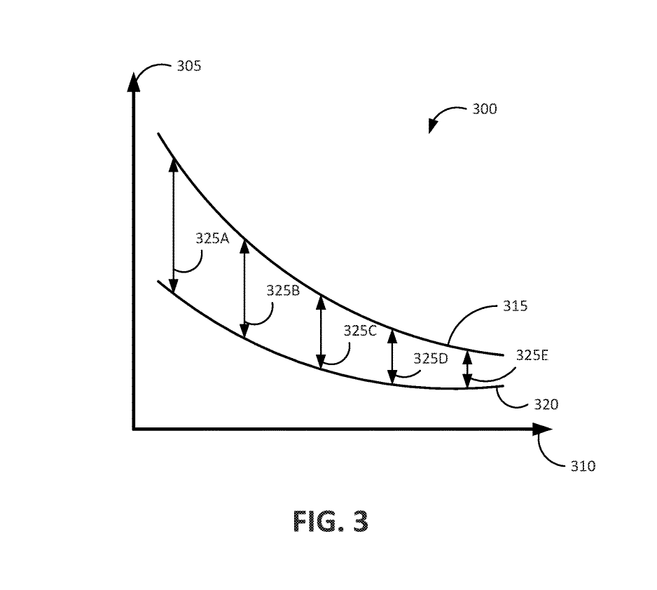

FIG. 3 is a graph illustrating a difference between response characteristics of layers of a multi-layer force sensor according to one embodiment. As illustrated here, the graph 300 includes a vertical axis 305 and a horizontal axis 310. The vertical axis 305 can represent the response characteristic, e.g., resistance, capacitance, etc., of the force sensitive layers of the multi-layer force sensor 100 while the horizontal axis 310 can represent the force applied to the multi-layer force sensor 100. The graph 300 also includes a response curve 315 for the first force sensitive layer 105 of the multi-layer force sensor 100 and a response curve 320 for the second force sensitive layer 110 of the multi-layer force sensor 100. As can be seen, the response curves 315 and 320 demonstrate the changes in the response characteristic of the layers of the multi-layer force sensor 100 as a force or pressure is applied. Also as can be seen, the response curves 315 and 320 demonstrate the difference in these responses due to the different materials used in the different layers of the multi-layer force sensor 100. These differences can be detected at various points 325A-325E along the response curves 315 and 320, e.g., by detecting the voltage difference between parallel branches of a bridge circuit 300 as described above. Once known, the detected difference can then be used to determine a value for the amount of force applied to the multi-layer force sensor 100.

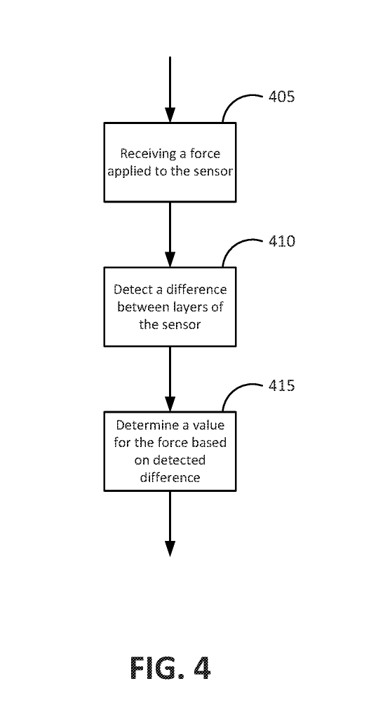

FIG. 4 is a flowchart illustrating a method for measuring force using a multi-layer force sensor according to one embodiment. As illustrated in this example, measuring force using a multi-layer force sensor 100 as described above can comprise receiving 405 a force applied to the multi-layer force sensor 100. The multi-layer force sensor 100 can comprise a first force sensitive layer 105 of a first force sensitive material and a second force sensitive layer 110 of a second force sensitive material. A response characteristic of the first force sensitive material for a range of force applied to the multi-layer force sensor 100 is different from the same response characteristic of the second force sensitive material for the same range of force applied to the multi-layer force sensor 100. A difference between the response of the first force sensitive material and the response of the second force sensitive material can be detected 410 and a value for an amount of force applied to the multi-layer force sensor 110 can be determined 415 based on the detected difference between the response of the first force sensitive material and the response of the second force sensitive material.

For example and as described above, the multi-layer force sensor 100 can comprise a bridge circuit 200, wherein the second force sensitive layer 110 is electrically connected with the first force sensitive layer 105 at a first intermediate point 220 of the bridge circuit 200, wherein a first bridge resistor 205 is electrically connected with the first force sensitive layer 105 of the multi-layer sensor at a second intermediate point 235 of the bridge circuit, wherein a second bridge resistor 210 is electrically connected with the first bridge resistor 205 at a third intermediate point 225 of the bridge circuit 200 and the second force sensitive layer 110 of the multi-layer force sensor 100 at a fourth intermediate point 240 of the bridge circuit 200. In such cases, the difference in response between the first and second force sensitive materials can be detected 410 between the second intermediate point 235 and fourth intermediate point 240 of the bridge circuit 200. In other words, parallel branches of the bridge circuit, each containing one of the force sensitive layers of the multi-layer force sensor, can be used to detect 410 the difference in the response characteristics of the different layers, e.g., by detecting the voltage difference between the parallel branches of the bridge circuit. This detected 410 difference can then be used to determine a value for the amount of force applied to the multi-layer force sensor 100 based on the known response characteristics of each of the force sensitive layers of the multi-layer force sensor 100.

The present disclosure, in various aspects, embodiments, and/or configurations, includes components, methods, processes, systems, and/or apparatus substantially as depicted and described herein, including various aspects, embodiments, configurations embodiments, sub combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A multi-layer force sensor comprising:
a first force sensitive layer of a first force sensitive material; and
a second force sensitive layer of a second force sensitive material, wherein a response of a characteristic of the first force sensitive material for a range of force applied to the multi-layer force sensor is different from a response of the same characteristic of the second force sensitive material for the same range of force applied to the multi-layer force sensor and wherein a difference between the response of the first force sensitive material and the response of the second force sensitive material indicates an amount of force applied to the multi-layer force sensor.

2. The multi-layer force sensor of claim 1, further comprising an intermediate layer between the first force sensitive layer and the second force sensitive layer.

3. The multi-layer force sensor of claim 1, further comprising one or more conductive leads electrically connected with each or the first force sensitive layer and the second force sensitive layer.

4. The multi-layer force sensor of claim 1, wherein the first force sensitive layer comprises a first Force Sensitive Resistor (FSR), wherein the second force sensitive layer comprises a second FSR, and wherein the characteristic comprises resistance of the first force sensitive material and the second force sensitive material.

5. The multi-layer force sensor of claim 4, wherein the first force sensitive material and the second force sensitive material comprise a conductive elastomer, a conductive foam, or a conductive ink.

6. The multi-layer force sensor of claim 1, wherein the first force sensitive layer comprises a first Force Sensitive Capacitor (FSC), wherein the second force sensitive layer comprises a second FSC, and wherein the characteristic comprises capacitance of the first force sensitive material and the second force sensitive material.

7. A bridge circuit comprising:
a first force sensitive layer of a multi-layer force sensor and comprising a first force sensitive material;
a second force sensitive layer of the multi-layer force sensor, the second force sensitive layer electrically connected with the first force sensitive layer at a first intermediate point of the bridge circuit and comprising a second force sensitive material, wherein a response of a characteristic of the first force sensitive material for a range of force applied to the multi-layer force sensor is different from a response of the same characteristic of the second force sensitive material for the same range of force applied to the multi-layer force sensor;
a first bridge resistor electrically connected with the first force sensitive layer of the multi-layer sensor at a second intermediate point of the bridge circuit; and
a second bridge resistor electrically connected with the first bridge resistor at a third intermediate point of the bridge circuit and the second force sensitive layer of the multi-layer force sensor at a fourth intermediate point of the bridge circuit, wherein a difference between the response of the first force sensitive material and the response of the second force sensitive material measured between the second intermediate point of the bridge circuit and fourth intermediate point of the bridge circuit indicates an amount of force applied to the multi-layer force sensor.

8. The bridge circuit of claim 7, further comprising an intermediate layer between the first force sensitive layer and the second force sensitive layer.

9. The bridge circuit of claim 7, wherein the first force sensitive layer comprises a first Force Sensitive Resistor (FSR), wherein the second force sensitive layer comprises a second FSR, and wherein the characteristic comprises resistance of the first force sensitive material and the second force sensitive material.

10. The bridge circuit of claim 9, wherein the first force sensitive material and the second force sensitive material comprise a conductive elastomer, a conductive foam, or a conductive ink.

11. The bridge circuit of claim 7, wherein the first force sensitive layer comprises a first Force Sensitive Capacitor (FSC), wherein the second force sensitive layer comprises a second FSC, and wherein the characteristic comprises capacitance of the first force sensitive material and the second force sensitive material.

12. A method for measuring force using a multi-layer force sensor, the method comprising:
receiving a force applied to the multi-layer force sensor, the multi-layer force sensor comprising a first force sensitive layer of a first force sensitive material and a second force sensitive layer of a second force sensitive material, wherein a response of a characteristic of the first force sensitive material for a range of force applied to the multi-layer force sensor is different from a response of the same characteristic of the second force sensitive material for the same range of force applied to the multi-layer force sensor;
detecting a difference between the response of the first force sensitive material and the response of the second force sensitive material; and
determining a value for a amount of force applied to the multi-layer force sensor based on the detected difference between the response of the first force sensitive material and the response of the second force sensitive material.

13. The method of claim 12, wherein the multi-layer force sensor further comprises a bridge circuit, wherein the second force sensitive layer is electrically connected with the first force sensitive layer at a first intermediate point of the bridge circuit, wherein a first bridge resistor is electrically connected with the first force sensitive layer of the multi-layer sensor at a second intermediate point of the bridge circuit, wherein a second bridge resistor electrically connected with the first bridge resistor at a third intermediate point of the bridge circuit and the second force sensitive layer of the multi-layer force sensor at a fourth intermediate point of the bridge circuit, and wherein the difference between the response of the first force sensitive material and the response of the second force sensitive material is detected between the second intermediate point of the bridge circuit and fourth intermediate point of the bridge circuit.

14. The method of claim 12, wherein the first force sensitive layer comprises a first Force Sensitive Resistor (FSR), wherein the second force sensitive layer comprises a second FSR, and wherein the characteristic comprises resistance of the first force sensitive material and the second force sensitive material.

15. The method of claim 14, wherein the first force sensitive material and the second force sensitive material comprise a conductive elastomer, a conductive foam, or a conductive ink.

16. The method of claim 12, wherein the first force sensitive layer comprises a first Force Sensitive Capacitor (FSC), wherein the second force sensitive layer comprises a second FSC, and wherein the characteristic comprises capacitance of the first force sensitive material and the second force sensitive material.
